(19) United States
(12) Patent Application Publication
(10) Pub. No.: US 2018/0063051 A1
(43) Pub. Date: Mar. 1, 2018

(54) SYSTEM FOR EXPORTING DIGITAL BUSINESS CARDS VIA AN EMAIL SIGNATURE LINK INTO A RECIPIENT'S ELECTRONIC DEVICES

(71) Applicant: David T. Chabukashvili, Madison, IN (US)

(72) Inventor: David T. Chabukashvili, Madison, IN (US)

(21) Appl. No.: 15/686,525

(22) Filed: Aug. 25, 2017

Related U.S. Application Data
(60) Provisional application No. 62/379,406, filed on Aug. 25, 2016.

(51) Int. Cl. H04L 12/58; H04L 29/08; G06F 17/30; G06F 17/22

(52) U.S. Cl. CPC H04L 51/08; H04L 67/02; H04L 51/063; G06F 17/2235; G06F 17/30014

(57) ABSTRACT

A system for exporting digital business card via an operatively associated email signature link into recipient's electronic devices is provided. The system embodies a software application providing an application logo attached to a sender's email signature or website, whereby if a recipient clicks the application logo a digital business card opens and allows the recipient to retrievably save the business card and associated information on the recipient computer and/or mobile electronic devices.

### CROSS-REFERENCE TO RELATED APPLICATION

This application claims the benefit of priority of U.S. provisional application No. 62/379,406, filed 25 Aug. 2016, the contents of which are herein incorporated by reference.

### BACKGROUND OF THE INVENTION

The present invention relates to management of electronic files and, more particularly, a system for exporting digital business card via an associated email signature link into recipient's electronic devices.

Currently the recipient of an email cannot receive business cards attached to the sender's signature and then transfer that business card to a digital business card application installed on their mobile electronic device, such as a smartphone and/or tablet.

The digital business card can only be attached to emails for viewing without allowing users to export and then save the business card information and card design to their mobile devices. This is because current devises and systems—including software that currently exists—do not have the capability of attaching the digital business cards using a hyper link icon embedded in the email's signature, wherein operatively engaging the icon makes the digital business cards exportable to mobile devices. This disadvantage reduces the effectiveness of the digital business card sharing.

Furthermore, email senders cannot attach business cards to their email signatures using such hyper link icon so that the digital business card could be viewed on the screen of computers or mobile devices by clicking the icon, thereby transferring the business card to smartphones and tablets upon receiving the email.

As can be seen, there is a need for a system for exporting digital business card via an email signature link into recipient's electronic devices, wherein the system embodies a software application allowing user-senders to attach a hyper link logo icon to their email signatures, wherein said logo icon is adapted to open and export the business card information, including the actual design of the card, to the user-recipient's electronic device. Thereby, the present invention helps email senders to share their electronic business cards to contacts more effectively, and on the other hand helps email recipients quickly store the business cards on their mobile electronic device.

### SUMMARY OF THE INVENTION

In one aspect of the present invention, a method for managing digital business cards through an electronic mail system includes providing the electronic mail system coupling a sender computer and at least one recipient computer, wherein a software application is adapted to perform the following steps: operatively associating at least one digital business card to a hyper link, wherein each digital business card comprises business information formatted to a card design; and embedding the hyper link in an electronic communication of the sender computer.

In another aspect of the present invention, the method for managing digital business cards through an electronic mail system includes providing the electronic mail system coupling a sender computer and at least one recipient computer, wherein a software application is adapted to perform the following steps: operatively associating at least one digital business card to a hyper link, wherein each digital business card adapts business information formatted to a card design; providing a template card in a form of memory of each recipient computer; coupling a readable optical label to each digital business card, wherein the readable optical label is configured to export the business information to the template card associated with each recipient computer scanning the readable optical label; and embedding the hyper link in a signature panel of an electronic communication of the sender computer, wherein the hyper link is adapted to open and export the digital business card to a recipient computer interacting with said hyper link.

These and other features, aspects and advantages of the present invention will become better understood with reference to the following drawings, description and claims.

### BRIEF DESCRIPTION OF THE DRAWINGS

FIG. 1 is a flow chart of an exemplary embodiment of the present invention illustrating the user-sender's process; and

FIG. 2 is a flow chart of an exemplary embodiment of the present invention illustrating the user-recipient's process.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system for exporting digital business card via an operatively associated email signature link into recipient's electronic devices. The system embodies a software application providing an application logo attached to a sender's email signature or website, whereby if a recipient clicks the application logo a digital business card opens and allows the recipient to retrievably save the business card and associated information on the recipient computer.

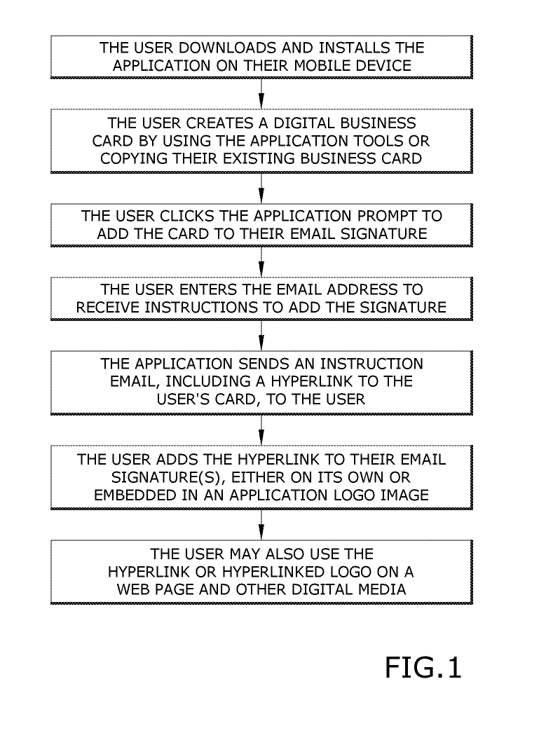

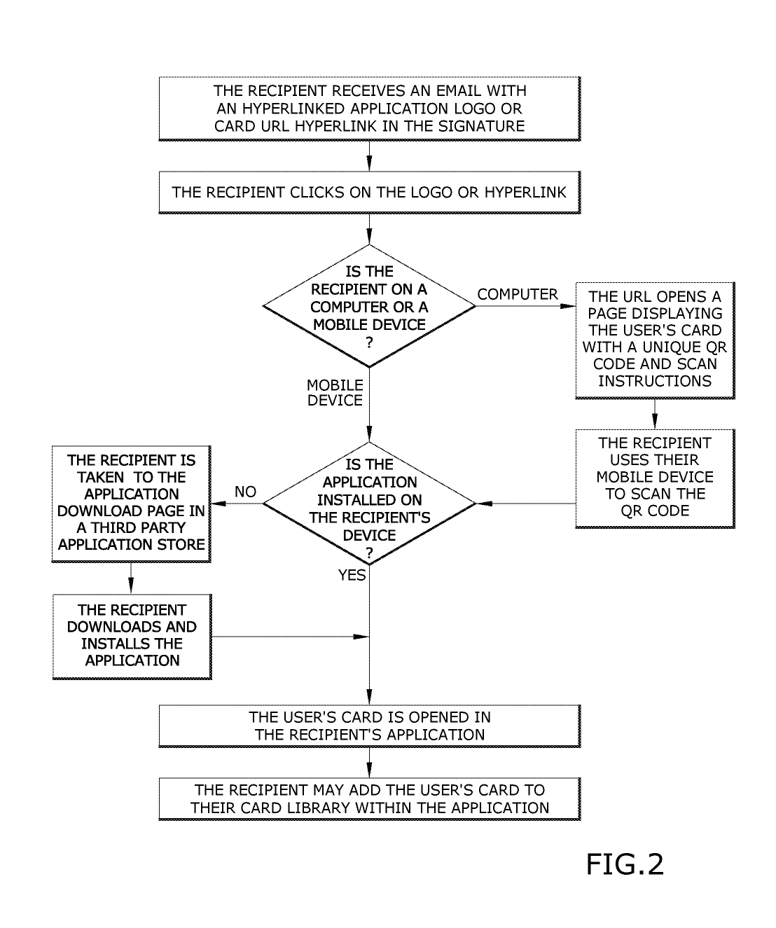

Referring now to FIGS. 1 through 2, the present invention may include at least one computer with a user interface. The computer may include at least one processing unit and a form of memory including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like. Coupled to the computer may be a plurality of computer peripherals such as a monitor, a keyboard, a mouse or other input devices for manipulating a cursor on the user interface, the monitor or the like.

The present invention may include an electronic mail system configuration coupling all computer and computer peripherals. In certain embodiments, the electronic mail system may embody a software application adapted so that when a user writes e-mail content the electronic mail system attaches a responsive logo icon to a signature panel operatively associated with the e-mail content, then sends the e-mail content to his/her contact. The e-mail content may include a digital business card, wherein the digital business card may provide an associated QRC (Quick Response Code) or other suitable machine-readable optical labeling. When a recipient receives the e-mail content, the user-recipient clicks the logo icon by using a mouse or other input device to open the sender's electronic business card created by the application. If a user-recipient receives the e-mail content to his/her computer, the user-recipient may aim their mobile electronic device and scans the readable optical labeling on said digital business card. Then user stores the scanned digital business card on the mobile application installed on the mobile electronic device. If user receives the e-mail content to the mobile electronic device, the user-recipient may click the logo icon to open the digital business card and stores it on the software application.

When user-senders select the card to be added to the signature panel the mobile software application may create the unique readable optical labeling for the card and converts the digital business card into a hyper link containing the card design and information. The software application, in some embodiments, may allow users to add the icon to the signature panel and copy and paste the responsive link to the application's URL, enabling the logo icon to open the stored information (e-mail content) by clicking it when received by contact/user-recipient. The software application then may enable reading the unique readable optical labeling by using an imaging device such as a camera of the mobile electronic device, exporting the scanned information into a card design to be retrievably stored on the user-recipient's software application.

In certain embodiments, if a user-recipient opens the e-mail content with the software application's responsive icon attached to the signature panel, said user-recipient may click the logo icon to open the business card just to view it, forward it, or save it to a card library. In certain embodiments, if the user-recipient receives the e-mail content on personal computer with either the application's responsive logo icon attached to a signature or just the electronic business card hyper link attached to the e-mail content, and the user-recipient does not have the software application installed on the mobile electronic device the user can still view the digital business card details without downloading the digital business card on those devices. The software application may enable the transfer of the card design, personal information and the picture of the user, and allow users to transfer the video messages to each other using electronic business cards so as to enhance the user experience. Also, in some embodiments, the software application may enable users to store the business card information partially or fully into the original contact libraries or card libraries of the personal computers or mobile devices will further enhance the user experience.

The electronic business cards with the readable optical labeling can be used for adding the electronic business cards to company websites and/or social network websites/sites using either just a hyper link or responsive hyper linked logo icons.

A method of using the present invention may include the following. The electronic mail system disclosed above may be provided. Referring to FIG. 1, a user may download the embodied software application on a mobile electronic device. The user then may create at least one electronic or digital business card using said application. Once the digital business card is created, the user may click the prompt “Add card to my signature”. Then the user types the e-mail address and submits it to the software application. After receiving the business card hyper link and special instructions the user may add the responsive logo icon to the signature, then further expand the e-mail content and send the e-mail content to a user-recipient, wherein the e-mail content is coupled with the business card's hyper link logo icon and the special instructions for how to add the card to a signature panel if using several different e-mail software.

The user may choose the logo icon shape from a provided list and add the responsive logo icon to the signature, then further expend the e-mail content and send the e-mail content to a user-recipient, wherein the e-mail content is coupled with the business card's hyper link logo icon.

Referring to FIG. 2, if the user-recipient receives the e-mail content on a personal computer and clicks the mobile application responsive logo icon it will open the URL page showing the electronic business card image together with the unique readable optical labeling and scan instructions. User then opens the scan feature of the same software application on the mobile electronic device to scan the readable optical labeling, storing the digital business card in an application's card library on the mobile electronic device. In case the recipient of the e-mail does not have the application installed on a mobile device and wants to learn more about the application the user can click the third party mobile applications store icon listed on the digital business card screen. If a recipient opens the email with the attached electronic business card hyper link and/or responsive icon on the mobile electronic device having the application the user can simply open the business card directly in the software application and store it in application's library. If the recipient of the e-mail does not have the application installed on a smartphone or tablet and clicks the business card hyper link and/or the responsive logo and the received e-mail will be automatically forwarded to the third party mobile application store to download the application.

The electronic business cards providing the readable optical labeling can be used for adding the electronic business cards to company websites and/or social network websites/sites using either just a hyper link or responsive hyper linked logo icons.

Additionally, the software application may allow users to transfer video and audio messages, video clips to each other using electronic business cards so as to enhance the user experience.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the present invention.

What is claimed is:

1. A method for managing digital business cards through an electronic mail system, comprising:
providing the electronic mail system coupling a sender computer and at least one recipient computer, wherein a software application is configured to perform the following steps:
operatively associating at least one digital business card to a hyper link, wherein each digital business card comprises business information formatted to a card design; and
embedding the hyper link in an electronic communication of the sender computer.

2. The method of claim 1, further comprising the step of embedding the hyper link in a signature panel of said electronic communication.

3. The method of claim 1, wherein the hyper link is a responsive hyper link logo icon.

4. The method of claim 1, wherein the hyper link is configured to open and export the digital business card to a recipient computer interacting with said hyper link.

5. The method of claim 1, wherein the software application is further configured to perform the step of coupling a readable optical label to each digital business card.

6. The method of claim 5, wherein the software application is further configured to perform the step of providing a template card in a form of memory of each recipient computer, wherein the readable optical label is configured to export the business information to the template card associated with each recipient computer scanning the readable optical label.

7. A method for managing digital business cards through an electronic mail system, comprising:
providing the electronic mail system coupling a sender computer and at least one recipient computer, wherein a software application is configured to perform the following steps:
operatively associating at least one digital business card to a hyper link, wherein each digital business card comprises business information formatted to a card design;
providing a template card in a form of memory of each recipient computer;
coupling a readable optical label to each digital business card, wherein the readable optical label is configured to export the business information to the template card associated with each recipient computer scanning the readable optical label; and
embedding the hyper link in a signature panel of an electronic communication of the sender computer, wherein the hyper link is configured to open and export the digital business card to said recipient computer interacting with said hyper link.

8. The method of claim 7, wherein the hyper link is a responsive hyper link logo icon.

9. The method of claim 7, wherein the at least one recipient computer is coupled to a company or social network website, and wherein the readable optical label is configured to export the business information and/or said hyper link to the template card associated with said company or social network website.
